(19) United States
(12) Patent Application Publication
(10) Pub. No.: US 2025/0232133 A1
(43) Pub. Date: Jul. 17, 2025

(54) METHOD, DEVICE, AND COMPUTER PROGRAM PRODUCT FOR BATCH PROCESSING A PLURALITY OF USER REQUESTS

(71) Applicant: Dell Products L.P., Round Rock, TX (US)

(72) Inventors: Qiang Chen, Shanghai (CN); Pedro Fernandez Orellana, Shanghai (CN)

(21) Appl. No.: 18/432,666

(22) Filed: Feb. 5, 2024

(30) Foreign Application Priority Data
Jan. 12, 2024 (CN) 202410054984.5

(51) Int. Cl. G06F 40/40; G06F 40/284

(52) U.S. Cl. CPC G06F 40/40; G06F 40/284

(57) ABSTRACT

Embodiments of the present disclosure relate to a method, a device, and a computer program product for batch processing a plurality of user requests. The method includes processing a plurality of user requests in a batch request by using a pre-trained language model. The method further includes inputting a candidate user request into the pre-trained language model when it is detected that the pre-trained language model outputs a response result corresponding to at least one user request. The method further includes processing the candidate user request and other user requests in the batch request by using the pre-trained language model, the other user requests including user requests other than the at least one user request in the batch request.

### RELATED APPLICATION

The present application claims priority to Chinese Patent Application No. 202410054984.5, filed Jan. 12, 2024, and entitled “Method, Device, and Computer Program Product for Batch Processing a Plurality of User Requests,” which is incorporated by reference herein in its entirety.

### FIELD

Embodiments of the present disclosure relate to the field of language models, and more specifically, to a method, a device, and a computer program product for batch processing a plurality of user requests.

### BACKGROUND

A language model illustratively comprises a natural language processing model based on deep learning. The language model can generate natural language texts with grammar and meaning by learning a large amount of text data. The language model plays an important role in natural language processing tasks such as part-of-speech tagging, syntactic analysis, machine translation, and information retrieval.

Currently, the language model can receive a plurality of user requests from a plurality of users in the same time period. In order to improve the utilization of a graphics processing unit (GPU) and throughput services of a language model, the language model can be used to process a plurality of user requests at one time. In a traditional batch processing strategy, a plurality of user requests are usually divided into batches for processing, so as to perform parallel computing on a GPU or other hardware.

### SUMMARY

Embodiments of the present disclosure relate to a method, a device, and a computer program product for batch processing a plurality of user requests.

According to a first aspect of the present disclosure, a method for batch processing a plurality of user requests is provided. The method includes processing a plurality of user requests in a batch request by using a pre-trained language model. The method further includes inputting a candidate user request into the pre-trained language model when it is detected that the pre-trained language model outputs a response result corresponding to at least one user request. The method further includes processing the candidate user request and other user requests in the batch request by using the pre-trained language model, the other user requests including user requests other than the at least one user request in the batch request.

According to a second aspect of the present disclosure, an electronic device is provided. The electronic device includes at least one processor, and a memory coupled to the at least one processor and having instructions stored therein, wherein the instructions, when executed by the at least one processor, cause the electronic device to perform actions comprising: processing a plurality of user requests in a batch request by using a pre-trained language model; inputting a candidate user request into the pre-trained language model when it is detected that the pre-trained language model outputs a response result corresponding to at least one user request; and processing the candidate user request and other user requests in the batch request by using the pre-trained language model, the other user requests including user requests other than the at least one user request in the batch request.

According to a third aspect of the present disclosure, a computer program product is provided. The computer program product is tangibly stored on a non-transitory computer-readable medium and includes machine-executable instructions, wherein the machine-executable instructions, when executed by a machine, cause the machine to perform steps of the method implemented in the first aspect of the present disclosure.

### BRIEF DESCRIPTION OF THE DRAWINGS

By description of example embodiments of the present disclosure in more detail with reference to the accompanying drawings, the above and other objectives, features, and advantages of the present disclosure will become more apparent. In the example embodiments of the present disclosure, the same reference numerals generally represent the same elements.

FIG. 1 illustrates an architectural diagram of a system for batch processing a plurality of user requests according to an embodiment of the present disclosure;

FIG. 2 illustrates a flow chart of a method for batch processing a plurality of user requests according to an embodiment of the present disclosure;

FIG. 3 illustrates a schematic diagram of time lengths required for a prefilling stage and a decoding stage of a pre-trained language model according to an embodiment of the present disclosure;

FIG. 4 illustrates a schematic diagram of simultaneously decoding a plurality of input sequences by using a pre-trained language model according to an embodiment of the present disclosure;

FIG. 5 illustrates a schematic diagram of memory partitioning according to an embodiment of the present disclosure;

FIG. 6 illustrates a schematic diagram of a process of adding a candidate user request in a pre-trained language model according to an embodiment of the present disclosure;

FIG. 7 illustrates a schematic diagram of a process of operation of a self-attention mechanism layer according to an embodiment of the present disclosure; and

FIG. 8 illustrates a block diagram of an example device suitable for implementing embodiments of contents of the present disclosure.

### DETAILED DESCRIPTION

Illustrative embodiments of the present disclosure will be described below in further detail with reference to the accompanying drawings. Although the accompanying drawings show some embodiments of the present disclosure, it should be understood that the present disclosure may be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for exemplary purposes only, and are not intended to limit the scope of protection of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

As mentioned above, in a traditional batch processing strategy, a plurality of user requests may be placed in one batch, and the plurality of user requests are input as a batch into a language model at one time. After being processed by the language model, response results corresponding to the plurality of user requests may be output. However, the traditional batch processing strategy may have a problem of high latency. This is because for each user request in the batch, the language model may generate a response result with different quantities of tokens, and response results corresponding to different user requests have different execution times. Therefore, before outputting, response results corresponding to all the user requests in the same batch must wait for a response result having the longest sequence length to be processed. This not only increases the processing latency of the language model, but also leads to underutilization of GPU computing resources, thereby reducing the processing efficiency of the language model.

To address these and other issues, an embodiment of the present disclosure provides a method for batch processing a plurality of user requests, and the method includes processing a plurality of user requests in a batch request by using a pre-trained language model. When it is detected that the pre-trained language model outputs a response result corresponding to at least one user request, a candidate user request is input into the pre-trained language model. The candidate user request and other user requests in the batch request are processed by using the pre-trained language model, wherein the other user requests include user requests other than the at least one user request in the batch request.

By using the method of the present disclosure, after the language model completes processing of one user request in the batch request, the language model can output the corresponding response result of the user request, and there is no need to wait for all processing results of other user requests to be generated before they can be output. Additionally, a candidate user request may be input into the language model, and the language model processes both the candidate user request and other requests in the batch request together. This not only can improve the memory utilization, but also can reduce the latency of the language model, thereby optimizing the user experience. In addition, when processing the plurality of user requests in the batch request, the language model does not need to align a plurality of input sequences corresponding to the plurality of user requests before performing the next operation, thereby saving the processing time and resources.

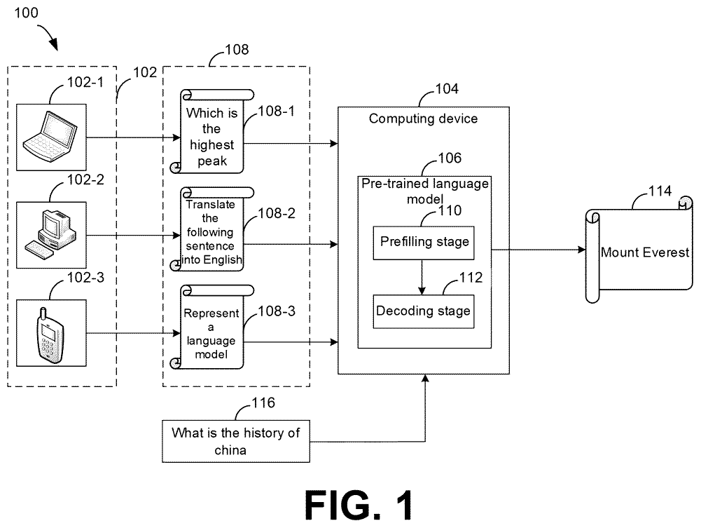

Fundamental principles and several example embodiments of the present disclosure will be described in detail below with reference to the accompanying drawings. FIG. 1 illustrates an architectural diagram of a system 100 for batch processing a plurality of user requests according to an embodiment of the present disclosure. It should be understood that the numbers and arrangement of components, elements, and systems illustrated in FIG. 1 are examples only, and the architectural diagram may include different numbers and different arrangements of components, elements, and systems.

As shown in FIG. 1, batch processing of a plurality of user requests 108 may include a plurality of terminal devices 102 (a terminal device 102-1, a terminal device 102-2, and a terminal device 102-3) and a computing device 104. The plurality of terminal devices 102 may be connected to computing device 104 through a network. For example, the terminal devices may be any type of mobile terminals, fixed terminals, or portable terminals, including a mobile phone, a site, a unit, a device, a multimedia computer, a multimedia tablet, an Internet node, a communicator, a desktop computer, a laptop computer, a notebook computer, a netbook computer, a tablet computer, a personal communication system (PCS) device, a personal navigation device, a personal digital assistant (PDA), an audio/video player, a digital camera/camcorder, a positioning device, a television receiver, a radio broadcast receiver, an e-book device, a gaming device, or any combination thereof, including accessories and peripherals of such devices, or any combination thereof.

In some embodiments, the computing device 104 may have common capabilities such as receiving and sending data requests, real-time data analysis, local data storage, and real-time network connectivity. For example, the computing device 104 may be any service terminal with computing capabilities. The service terminal may be servers provided by various service providers, large-scale computing devices, and the like. The computing device 104 may include a pre-trained language model 106. The pre-trained language model 106 may use large-scale unlabeled data for unsupervised learning, thereby learning general rules and patterns of language, so that the pre-trained language model 106 may output responses that conform to the rules based on user requests.

In some embodiments, a user may input task information of a to-be-processed task on the terminal device 102, and the terminal device 102 may generate a user request 108 (such as a user request 108-1, a user request 108-2, and a user request 108-3) based on the task information input by the user. The to-be-processed task may be a task that the user wants to execute or process, such as a text generation task (creating a College Admission Essay), an image generation task (drawing an image of a cat wearing armor), and a text translation task (translating the following sentence into English). For example, a user A may log in to the terminal device 102-1 and input, by using the keyboard input, task information for a to-be-processed task, such as “which is the highest peak?” The terminal device 102-1 may generate a corresponding user request 108-1 based on the task information input by the user.

In some embodiments, a plurality of terminal devices 102 may send a plurality of user requests to the pre-trained language model 106 in the computing device 104. The pre-trained language model 106 may divide the plurality of user requests 108 into a plurality of batch requests, and process the plurality of user requests 108 in the batch requests in batches. As shown in FIG. 1, the user request 108-1, the user request 108-2, and the user request 108-3 may be combined to generate a batch request. In other words, the batch request may include a plurality of user requests such as the user request 108-1, the user request 108-2, and the user request 108-3. All the user requests 108 in the batch request are input into the pre-trained language model 106, and the pre-trained language model 106 processes the plurality of user requests 108 in the batch request together. In some embodiments, due to the fact that the pre-trained language model 106 cannot directly process a natural language, it is necessary to perform feature extraction from text information (such as “the nutritional value of strawberries”) contained in the user request 108 to obtain an input sequence corresponding to the user request 108. The input sequence includes a plurality of tokens. The tokens are atomic parts of the pre-trained language model 106 processing the natural language. A token in some embodiments illustratively contains approximately four English characters.

It is to be understood that the pre-trained language model 106 illustratively includes two stages of inference for the user request 108: a prefilling stage 110 and a decoding stage 112. In the prefilling stage 110 (an “encoding” or “initialization” stage), the pre-trained language model 106 may receive the input sequence and generate a subsequent token (a “first” token), and perform a forward pass processing on the input sequence and the “first” token as a whole. In this process, the prefilling stage may also generate a Key Value (KV) tensor. It should be noted that the input sequence may provide a starting point for the pre-trained language model 106, so that the pre-trained language model 106 can understand the request of the user and generate a corresponding response result.

In the decoding stage 112, the pre-trained language model 106 may continuously generate new tokens in an autoregression manner until a stop condition is met (reaching a set maximum sequence length or generating a special marker symbol, such as a symbol <end> or a symbol <eos>, “that indicates stopping of a generation process”). When the stop condition is met, the pre-trained language model 106 may output the response result corresponding to the user request. The decoding process of the pre-trained language model 106 is an iterative process, and with each forward pass, the pre-trained language model 106 generates an additional token, thereby gradually constructing a complete output sequence (response result). In each iteration process, a new KV tensor may be generated. Reaching the set maximum sequence length means that the number of generated tokens reaches an upper limit. The response result may be an output sequence corresponding to the input sequence, and the output sequence contains the token generated in each iteration process.

In a traditional batch request, in order to process a plurality of input sequences corresponding to a plurality of user requests simultaneously, it is necessary to fill the plurality of input sequences to the same sequence length. Additionally, the plurality of input sequences need to be prefilled and decoded together. This also means that even if one or a plurality of requests have met an iteration stop criteria, decoding must still continue until the pre-trained language model concludes the inference of the entire batch request. Such processing methods cannot fully utilize the GPU memory space and may also waste processing resources. On this basis, the method provided in the present disclosure does not require alignment operations on a plurality of input sequences of different lengths.

In some embodiments, the pre-trained language model 106 may decode a plurality of input sequences that are not aligned. It is to be understood that decoding operations of the plurality of input sequences in some embodiments are performed synchronously, and the various input sequences may generate the next tokens at the same time in one iteration process. Due to the different lengths of the input sequences, the lengths of output sequences corresponding to the input sequences are also different. Therefore, the generation times of response results corresponding to a plurality of user requests in the same batch request are also different. As shown in FIG. 1, the pre-trained language model 106 first generates a response result 114 corresponding to the user request 108-1. In this case, in order to improve the GPU utilization, a candidate user request 116 may be input to the pre-trained language model 106, taking over the position of the user request 108-1. The pre-trained language model 106 continues to perform inference on other user requests 108 (the user request 108-2 and the user request 108-3) and the candidate user request 116, thereby generating a plurality of response results. The above operations are repeated until the pre-trained language model 106 completes the inference corresponding to all the user requests.

In this way, in the inference process of the pre-trained language model, new user requests may be continuously added to the current batch, which utilizes the memory bandwidth more effectively and improves the computational utilization and throughput. In addition, the user requests of the same batch do not need to wait for the entire batch of user requests to generate response results in order to obtain the output response results, thereby reducing the processing delay of the pre-trained language model.

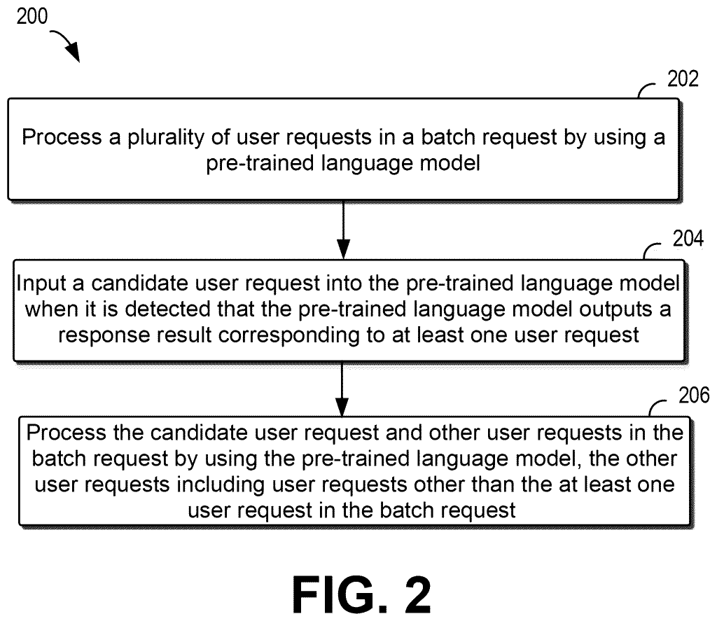

The schematic diagram in which the method and/or process according to embodiments of the present disclosure may be implemented is described above with reference to FIG. 1. A flow chart of a method 200 for batch processing a plurality of user requests according to an embodiment of the present disclosure will be described below with reference to FIG. 2. The method 200 for batch processing a plurality of user requests according to an embodiment of the present disclosure may be performed at an edge device with computing power or at a cloud server, and the present disclosure is not limited in this regard.

As shown in FIG. 2, at block 202, the method 200 may process a plurality of user requests in a batch request by using a pre-trained language model (such as the pre-trained language model 106 shown in FIG. 1). The batch request refers to a plurality of user requests contained in one batch executed by the pre-trained language model at one time. The batch request contains two or more user requests. The user requests may include various types, such as generation requests, classification requests, and inference requests. The generation requests may include but are not limited to text generation requests, image generation requests, voice generation requests, and the like. The classification requests may include but are not limited to text classification requests, image classification requests, clustering requests, and the like. The inference requests may include numerical prediction requests and image recognition requests.

In some embodiments of the present disclosure, user requests in the same batch may originate from different users and different clients, and types of the user requests in the same batch may also be different. In some examples, when there are 25 user requests to be processed, the 25 user requests may be divided into 5 batches according to a rule of 5 in a batch. The size of a batch may be set by a user according to the performance of the pre-trained model and actual application requirements, such as 3, 5, and 50 user requests.

It should be understood that before inputting user requests into the pre-trained language model, feature extraction may be performed on the user requests to determine corresponding input sequences of the user requests. The lengths of the input sequences corresponding to different user requests may be inconsistent. The length of the input sequence refers to the number of tokens contained in the input sequence. When the pre-trained language model performs inference on the plurality of input sequences in the batch request, it is not necessary to align the lengths of the plurality of input sequences. That is, it is not necessary to use special characters to fill in the input sequence with a shorter length to increase its length.

In some embodiments of the present disclosure, the processing of an input sequence corresponding to a user request by the pre-trained language model includes prefilling processing and decoding processing. The prefilling processing refers to the pre-trained language model receiving the input sequence and generating a “first” token based on the input sequence. The decoding processing refers to the pre-trained language model generating the next token according to the input sequence and the “first” token, passing forward the generated next token, the previous input sequence, and the “first” token, iteratively generating the next token until an iteration stop condition is reached, and outputting an output sequence (response result) composed of a plurality of generated tokens. The iteration stop condition refers to the length of the generated output sequence reaching a set maximum sequence length or a specific “stop” mark (such as <cos> or <end>) indicating the termination of a generation process is generated. It should be noted that the decoding operations of the pre-trained language model on the plurality of input sequences are performed synchronously. That is, in each iteration process, a next token corresponding to each input sequence may be generated.

As shown in FIG. 2, at block 204, the method 200 may input a candidate user request to the pre-trained language model when it is detected that the pre-trained language model outputs a response result corresponding to at least one user request. Due to the different lengths of the input sequences, lengths of corresponding output sequences are also different. The different output sequences may be generated in different iteration steps in batch processing. Therefore, the time required for the pre-trained language model to output response results corresponding to different user requests is also different. In order to reduce the processing delay of user requests and improve the GPU utilization, a plurality of user requests in the same batch do not need to wait for the inference process of other user requests, and the corresponding response results may be output immediately after being obtained.

It should be understood that in order to process a plurality of user requests more efficiently, a candidate user request may be input into the pre-trained language model. The candidate user request may be a user request from another batch request or a newly generated user request. After the response result corresponding to at least one user request is output, resources occupied by the user request may be released. The candidate user request may take over the user request, and the candidate user request may be prefilled and decoded by using the pre-trained language model within a GPU memory originally allocated to the user request. In this way, the waste of GPU resources may be reduced and the utilization rate of the GPU resources may be improved.

As shown in FIG. 2, at block 206, the method 200 may process the candidate user request and other user requests in the batch request by using the pre-trained language model. The other user requests refer to user requests in this batch request of which response results have not been output. The pre-trained language model may add the candidate user request to the batch request, process the batch request simultaneously, and generate next tokens in output sequences corresponding to various user requests.

By using this method, after the pre-trained language model completes processing of one user request in the batch request, the pre-trained language model can output the corresponding response result of the user request, and there is no need to wait for all processing results of other user requests to be generated before they can be output. Additionally, the candidate user request may be input into the language model, and the language model processes both the candidate user request and other requests in the batch request together. In this way, the computing resources of the GPU may be more flexibly utilized to improve the utilization of the GPU, and the latency of pre-trained language models may also be reduced, thereby optimizing the user experience. In this process, once a response result is generated and output, the next candidate user request may be immediately processed, thereby minimizing the idle time of the GPU. In addition, when processing a plurality of user requests in the batch request, the pre-trained language model does not need to align a plurality of input sequences corresponding to the plurality of user requests before performing the next operation, thereby saving processing time and processing resources.

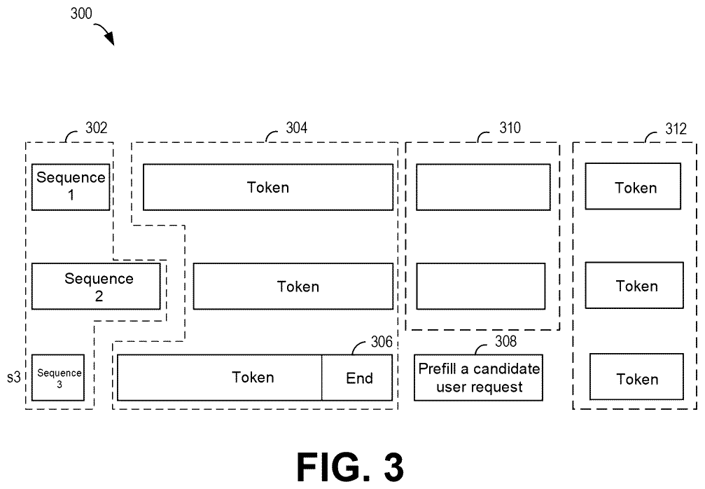

In some embodiments of the present disclosure, after outputting the response result corresponding to at least one user request and before inputting the candidate user request into the pre-trained language model, the pre-trained language model may continue to perform decoding operations on other user requests in the batch request without being affected. In other embodiments of the present disclosure, in order to save processing resources and reduce processing costs, after outputting the response result corresponding to at least one user request and before prefilling the candidate user request, the decoding operations on the input sequences corresponding to other user requests by the pre-trained language model may be suspended. FIG. 3 illustrates a schematic diagram 300 of time lengths required for a prefilling stage and a decoding stage of a pre-trained language model according to some embodiments of the present disclosure. As shown in FIG. 3, a plurality of misaligned input sequences may be prefilled 302. If an input sequence s3 generates an end marker symbol (such as an <end> marker symbol) 306 in a decoding stage 304, a candidate user request may be input into the pre-trained language model. After prefilling the candidate user request, the pre-trained language model performs decoding operations on the candidate user request and other user requests. It should be noted that decoding 310 of other input sequences is temporarily suspended until the prefilling of the candidate user request is completed. A runtime 308 of the prefilling is equivalent to a runtime 312 of one iteration process (generating one token) in the decoding stage. Therefore, after outputting the response result corresponding to at least one user request and before prefilling the candidate user request, suspending the decoding operations on the input sequences corresponding to other user requests by the pre-trained language model will not affect the processing efficiency of the batch of user requests.

In some embodiments of the present disclosure, in order to make reasonable use of the parallel computing power of the GPU and reduce redundant computing work, a plurality of user requests in the batch request may be merged, and the pre-trained language model may simultaneously perform a decoding operation on the plurality of user requests. However, due to the fact that the input sequences corresponding to the plurality of user requests are not aligned in the prefilling process of the plurality of user requests, and the decoding processing of the pre-trained language model is mostly tensor calculation, irregular tensors composed of the plurality of misaligned input sequences are calculated by using the calculation method provided in embodiments of the present disclosure.

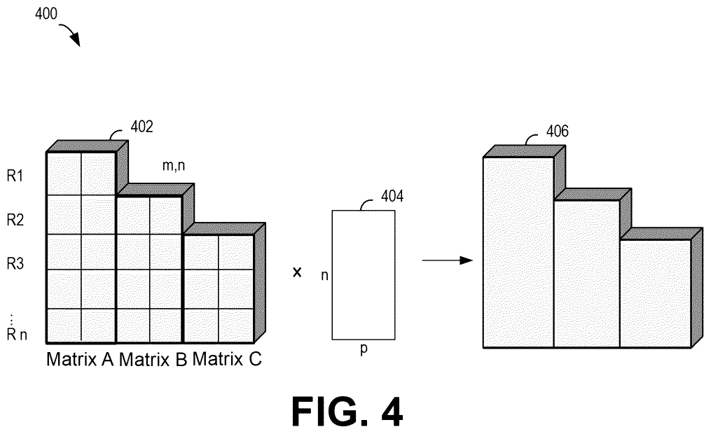

FIG. 4 illustrates a schematic diagram 400 of simultaneously decoding a plurality of input sequences by using a pre-trained language model according to an embodiment of the present disclosure. As shown in FIG. 4, before decoding a plurality of input sequences, it is necessary to record a plurality of sequence lengths corresponding to the plurality of input sequences. For example, the length of an input sequence A is 30, and the length of an input sequence B is 50. It should be understood that during each iteration operation, the sequence length of the current sequence is required. After obtaining the sequence lengths (such as R1, R2, . . . , and Rn) corresponding to the plurality of input sequences (such as s1, s2, . . . , and sn), an irregular matrix 402 constructed by the plurality of input sequences may be partitioned into blocks, such as a matrix A, a matrix B, and a matrix C. The size of the irregular matrix 402 may be (R1, R2, . . . , and Rn)×m×n, wherein m is the number of tokens, and n is the size of the pre-trained language model. As shown in FIG. 4, the irregular matrix may be multiplied by a network parameter matrix 404 n×p representing the pre-trained language model to obtain a corresponding matrix 406, so as to complete one iteration operation, wherein p is the number of network parameters for the pre-trained language model.

In this way, decoding operations may be performed on a plurality of misaligned input sequences simultaneously, thereby reducing the number of model parameter loads, more effectively utilizing these memory bandwidths, and improving the processing efficiency of the pre-trained model and the utilization of GPU.

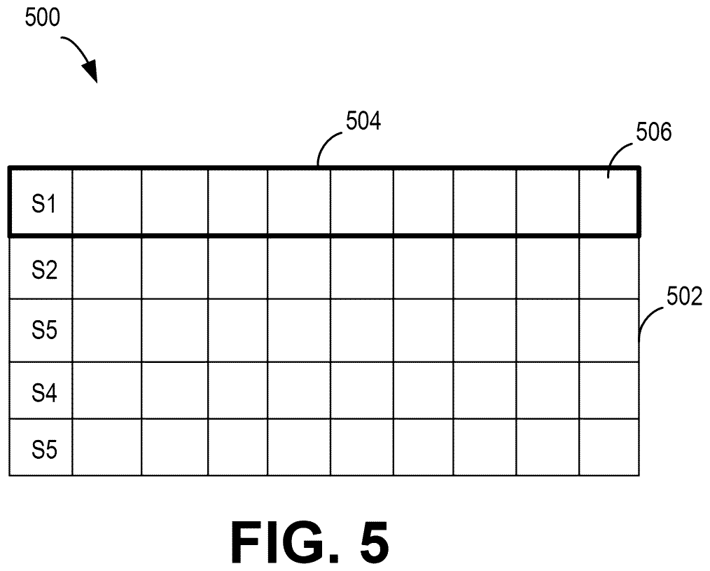

In some embodiments, the model parameter, input sequence, and output sequence of the pre-trained language model may be stored in the GPU (or a CPU) memory. In order to allocate the GPU memory reasonably and improve the utilization of the GPU memory, the GPU memory may be partitioned into a plurality of physical blocks in advance, and then a predetermined number (such as 8, 10, and 15) of physical blocks may be allocated to an input sequence. In this way, the maximum sequence length of an input sequence is a predetermined number. FIG. 5 illustrates a schematic diagram 500 of memory partitioning according to an embodiment of the present disclosure. As shown in FIG. 5, a GPU memory 502 may be partitioned into a plurality of physical blocks 506, and a memory 504 allocated for an input sequence S1 includes 10 physical blocks 506.

In some embodiments, each token requires a certain amount of memory to store its encoding and related information. Therefore, as the length of an output sequence increases, memory consumption also increases. In order to ensure that the pre-trained model can output output sequences corresponding to different user requests, it is necessary to dynamically adjust the maximum sequence length when the sum of the length of an output sequence and the length of an input sequences exceeds a set maximum sequence length. For example, when 50 physical blocks of the memory are pre-allocated to a user request A, the length of an input sequence corresponding to the user request A is 30, and the length of an output sequence is 40, an additional 20 physical blocks need to be allocated to the user request A to ensure that the pre-trained language model can output a response result corresponding to the user request A.

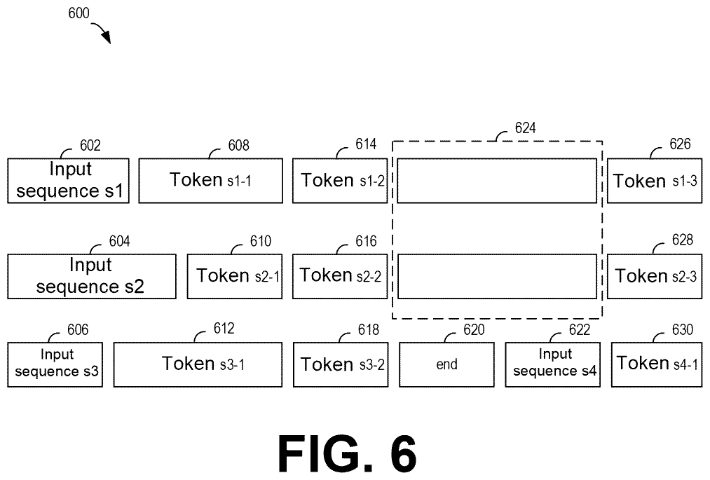

FIG. 6 illustrates a schematic diagram 600 of a process of adding a candidate user request in a pre-trained language model according to an embodiment of the present disclosure. As shown in FIG. 6, the pre-trained language model may generate “first” tokens (such as a token s1-1 608, a token s2-1 610, and a token s3-1 612) after receiving an input sequence s1 602, an input sequence s2 604, and an input sequence s3 606, respectively. In the decoding stage, during the first iteration, the pre-trained language model may generate the next tokens (such as a token s1-2 614, a token s2-2 616, and a token s3-2 618) based on the input sequences and the “first” tokens. In the second iteration process, the next token corresponding to the input sequence s3 606 is an end marker symbol 620. Afterwards, an output sequence (a response result corresponding to at least one user request) consisting of the token s3-1 612 and the token s3-2 618 may be output. At the same time, a candidate user request may be input to the pre-trained language model and prefilled by the pre-trained language model, so as to determine a corresponding input sequence s4 622. During this period, the pre-trained language model suspends decoding operations 624 performed on the input sequence s1 602 and the input sequence s2 604. Afterwards, decoding operations may be performed on the input sequence s4 622, the input sequence s1 602, and the input sequence s2 604 together to generate respective corresponding next tokens (such as a token s1-3 626, a token s2-3 628, and a token s4-1 630).

It should be understood that before processing the candidate user request, it is necessary to first determine whether the memory space corresponding to the user request that generates the response result is available. If the memory space is available, the candidate user request is prefilled and decoded in the memory space by using the pre-trained language model. If the memory space is unavailable, it is necessary to allocate a new memory space for the candidate user request to ensure the normal inference by the pre-trained language model on the candidate user request, thereby outputting a response result corresponding to the candidate user request.

In a known tensor calculation process corresponding to batch processing, it is necessary to align a plurality of input sequences in advance, that is, the lengths of the input sequences need to be consistent. After aligning the plurality of input sequences, in order to reduce the number of model parameter loads, the plurality of input sequences may be combined to generate a matrix X of size [B, S, D].

In the process of prefilling or decoding, some or most of the operations may be matrix multiplication operations. For example, the matrix generated by the combination may be multiplied by a parameter matrix W of size [D, H, A], resulting in a matrix Q of size [B, S, H, A], wherein B is the size of the batch, S is the length of the plurality of aligned input sequences, D is the size of the pre-trained language model, H is the number of multi-head attention layers, and A is the size of the multi-head attention layers. In some embodiments, the operational logic for matrix multiplication is Q[b,s,h,a]=X[b,s,d]*W[d,h,a], wherein b is an element in an array B, s is an element in an array S, d is an element in an array D, h is an element in an array H, and a is an element in an array A. It should be understood that operations on a matrix composed of the plurality of input sequences may be expanded into loop multiplication of nested and uniform elements, so as to ensure that normal matrix multiplication operations can be performed on the matrix. In an embodiment of the present disclosure, the lengths of the plurality of input sequences corresponding to the plurality of user requests are not uniform, so that the combination of the plurality of input sequences is not a conventional matrix, but an irregular matrix. On this basis, an array may be used to record lengths of various input sequences in the current iteration process, so as to ensure that the next tokens corresponding to the plurality of input sequences can be output simultaneously in one iteration. For example, the plurality of input sequences may be combined to generate a matrix X[B, T, D], wherein B is a one-dimensional array used for recording sequence lengths of a plurality of sequences in each iteration process of prefilling or decoding. T refers to the set maximum sequence length, and is the maximum sequence length among the memory lengths allocated for the plurality of input sequences.

As indicated above, in the process of prefilling or decoding, some or most of the operations may be matrix multiplication operations. Again by way of example, the matrix generated by the combination may be multiplied with a parameter matrix W[D, H, A] of the pre-trained language model to obtain a matrix Q of size [B, S, H, A], wherein B is the size of the batch, S is the length of the plurality of aligned input sequences, D is the size of the pre-trained language model, H is the number of multi-head attention layers, and A is the size of the multi-head attention layers. In some embodiments, the operational logic for matrix multiplication is Q[b,s,h,a]=X[b,s,d]*W[d,h,a], wherein b is an element in an array B, s is an element in an array T, d is an element in an array D, h is an element in an array H, and a is an element in an array A. If the length L (b) of the current sequence is greater than the maximum sequence length, the sequence will not be processed (decoded). If the length L (b) of the current sequence is less than the maximum sequence length, it may be processed according to the conventional matrix multiplication rule Q[b,s,h,a]=X[b,s,d]*W[d,h,a].

Also as indicated previously, it should again be appreciated that the operations performed on the irregular matrix composed of a plurality of input sequences may still be expanded into a loop of multiplication of nested matrix elements. In other words, normal matrix multiplication operations may be guaranteed for the irregular matrix. In some embodiments, the pre-trained language model mainly includes a plurality of attention mechanism-based network layers, with the various layers sharing the same architecture. For example, each layer illustratively includes a dense layer projection, a self-attention mechanism layer, and a feed-forward-network layer. Taking the self-attention mechanism layer as an example, the decoding process of the pre-trained language model is further described below.

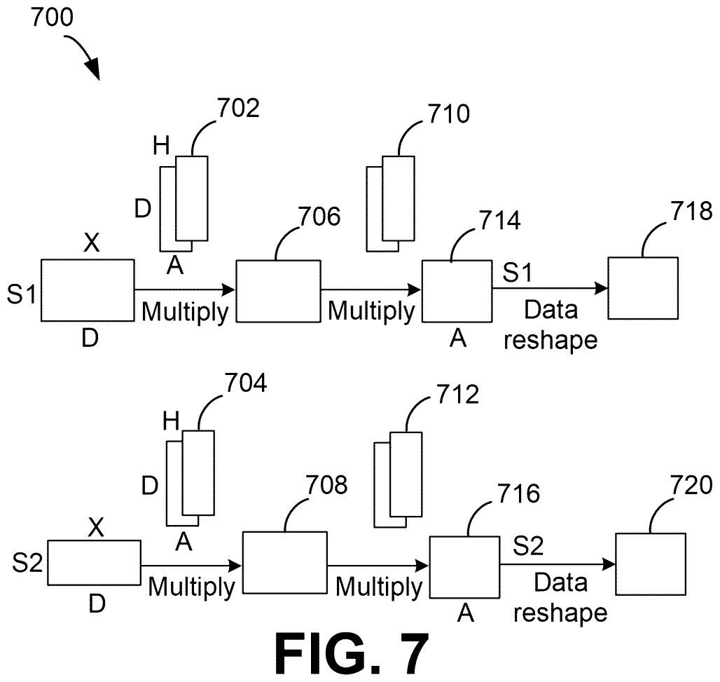

FIG. 7 illustrates a schematic diagram 700 of a process of operation of a self-attention mechanism layer according to an embodiment of the present disclosure. As shown in FIG. 7, a batch request contains two input sequences with different lengths, S1 and S2, respectively. The input sequence with the length S1 is multiplied with a parameter matrix 702 of the pre-trained language model to obtain a matrix 706. It should be noted that the shape of matrix 706 is related to the length of the input sequence. The matrix 706 is multiplied with a generated KV tensor 710 to obtain a matrix 714. The shape of the matrix 714 is related to the length of the input sequence. Afterwards, data reshaping may be performed on the matrix 714 to obtain a response result 718 corresponding to the input sequence. Similarly, the decoding operation of the input sequence with the length S2 is similar to the decoding operation of the input sequence with the length S1, but with corresponding parameter matrix 704, matrix 708, KV tensor 712, matrix 716 and response result 720, and will therefore not be further elaborated herein.

It should be understood that when performing matrix multiplication, the self-attention mechanism layer supports matrix multiplication of an irregular matrix composed of a plurality of misaligned input sequence. Additionally, the KV tensor and the parameter matrix are independent of the length of the input sequence, and therefore, alignment operations may be performed in a batch processing manner.

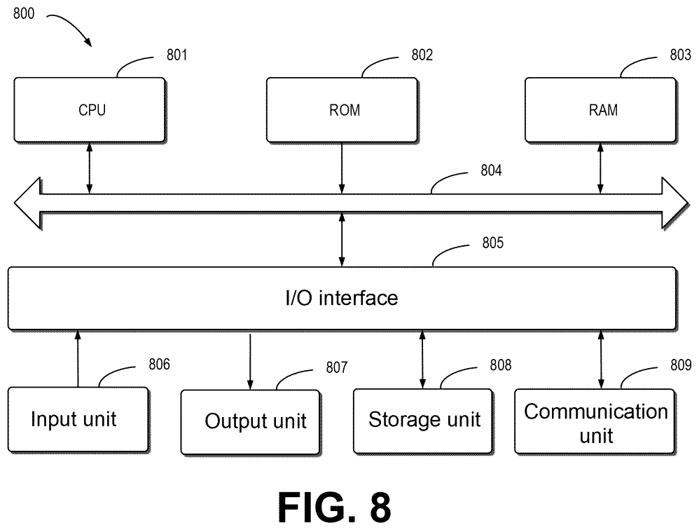

FIG. 8 shows a block diagram of an example device 800 that can be used to implement an embodiment of the present disclosure. The computing device in FIG. 1 may be implemented by using the device 800. As shown in the figure, the device 800 includes a central processing unit (CPU) 801 that may execute various appropriate actions and processing according to computer program instructions stored in a read-only memory (ROM) 802 or computer program instructions loaded from a storage unit 808 to a random access memory (RAM) 803. In the RAM 803, various programs and data required for the operation of the device 800 may also be stored. The CPU 801, the ROM 802, and the RAM 803 are connected to each other through a bus 804. An input/output (I/O) interface 805 is also connected to the bus 804.

A plurality of components in the device 800 are connected to the I/O interface 805, including: an input unit 806, such as a keyboard and a mouse; an output unit 807, such as various types of displays and speakers; the storage unit 808, such as a magnetic disk and an optical disc; and a communication unit 809, such as a network card, a modem, and a wireless communication transceiver. The communication unit 809 allows the device 800 to exchange information/data with other devices via a computer network, such as the Internet, and/or various telecommunication networks.

The various processes and processing procedures described above, such as the method 200, may be performed by the CPU 801. For example, in some embodiments, the method 200 may be implemented as a computer software program that is tangibly included in a machine-readable medium, such as the storage unit 808. In some embodiments, some or all of the computer program may be loaded and/or installed onto the device 800 via the ROM 802 and/or the communication unit 809. One or a plurality of actions of the method 200 described above may be performed when the computer program is loaded into the RAM 803 and executed by the CPU 801.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, wherein the programming languages include object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or more blocks in the flow charts and/or block diagrams.

The computer-readable program instructions may also be loaded to a computer, another programmable data processing apparatus, or another device, so that a series of operating steps can be performed on the computer, the other programmable data processing apparatus, or the other device to produce a computer-implemented process, such that the instructions executed on the computer, the other programmable data processing apparatus, or the other device can implement the functions/actions specified in one or more blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or more executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated embodiments. The selection of terms as used herein is intended to best explain the principles and practical applications of the various embodiments and their associated technical improvements, so as to enable persons of ordinary skill in the art to understand the embodiments disclosed herein.

What is claimed is:

1. A method for batch processing a plurality of user requests, comprising:
processing a plurality of user requests in a batch request by using a pre-trained language model;
inputting a candidate user request into the pre-trained language model when it is detected that the pre-trained language model outputs a response result corresponding to at least one user request; and
processing the candidate user request and other user requests in the batch request by using the pre-trained language model, the other user requests comprising user requests other than the at least one user request in the batch request.

2. The method according to claim 1, further comprising:
suspending, during a period of inputting the candidate user request into the pre-trained language model, decoding processing of other user requests by the pre-trained language model.

3. The method according to claim 2, wherein processing the candidate user request and other user requests in the batch request by using the pre-trained language model comprises:
prefilling the candidate user request by using the pre-trained language model; and
decoding, after the prefilling is completed, the candidate user request and the other user requests by using the pre-trained language model.

4. The method according to claim 1, wherein processing a plurality of user requests in a batch request by using a pre-trained language model comprises:
determining a plurality of sequence lengths corresponding to the plurality of user requests; and
processing the plurality of user requests by using the pre-trained language model based on the plurality of sequence lengths.

5. The method according to claim 4, wherein processing the plurality of user requests by using the pre-trained language model based on the plurality of sequence lengths comprises:
constructing, by combining a plurality of input sequences corresponding to the plurality of user requests, an irregular matrix corresponding to the plurality of input sequences;
determining a target matrix by partitioning the irregular matrix based on the plurality of sequence lengths; and
decoding the plurality of input sequences based on the target matrix and a parameter matrix of the pre-trained language model.

6. The method according to claim 1, wherein processing the candidate user request and other user requests in the batch request by using the pre-trained language model comprises:
determining whether a memory space corresponding to the response result is available; and
processing, in response to the memory space being available, the candidate user request in the memory space by using the pre-trained language model, the processing comprising prefilling and decoding.

7. The method according to claim 6, further comprising:
in response to the memory space being unavailable, acquiring an empty target memory space; and
processing the candidate user request in the target memory space by using the pre-trained language model.

8. The method according to claim 1, further comprising:
partitioning a memory space into a plurality of physical blocks of the same size; and
assigning a predetermined number of physical blocks to a plurality of user requests in the batch request.

9. The method according to claim 1, further comprising:
determining whether a length of an input sequence corresponding to a given one of the user requests and a length of an output sequence corresponding to the input sequence are greater than a maximum sequence length; and
dynamically adjusting the maximum sequence length in response to the lengths being greater than the maximum sequence length.

10. The method according to claim 1, wherein the user requests comprise any one of text generation, image generation, text classification, speech generation, and image description requests.

11. An electronic device, comprising:
at least one processor; and
a memory coupled to the at least one processor and having instructions stored therein, wherein the instructions, when executed by the at least one processor, cause the electronic device to perform actions comprising:
processing a plurality of user requests in a batch request by using a pre-trained language model;
inputting a candidate user request into the pre-trained language model when it is detected that the pre-trained language model outputs a response result corresponding to at least one user request; and
processing the candidate user request and other user requests in the batch request by using the pre-trained language model, the other user requests comprising user requests other than the at least one user request in the batch request.

12. The electronic device according to claim 11, further comprising:
suspending, during a period of inputting the candidate user request into the pre-trained language model, decoding processing of other user requests by the pre-trained language model.

13. The electronic device according to claim 12, wherein processing the candidate user request and other user requests in the batch request by using the pre-trained language model comprises:
prefilling the candidate user request by using the pre-trained language model; and
decoding, after the prefilling is completed, the candidate user request and the other user requests by using the pre-trained language model.

14. The electronic device according to claim 11, wherein processing a plurality of user requests in a batch request by using a pre-trained language model comprises:
determining a plurality of sequence lengths corresponding to the plurality of user requests; and
processing the plurality of user requests by using the pre-trained language model based on the plurality of sequence lengths.

15. The electronic device according to claim 14, wherein processing the plurality of user requests by using the pre-trained language model based on the plurality of sequence lengths comprises:
constructing, by combining a plurality of input sequences corresponding to the plurality of user requests, an irregular matrix corresponding to the plurality of input sequences;
determining a target matrix by partitioning the irregular matrix based on the plurality of sequence lengths; and
decoding the plurality of input sequences based on the target matrix and a parameter matrix of the pre-trained language model.

16. The electronic device according to claim 11, wherein processing the candidate user request and other user requests in the batch request by using the pre-trained language model comprises:
determining whether a memory space corresponding to the response result is available; and
processing, in response to the memory space being available, the candidate user request in the memory space by using the pre-trained language model, the processing comprising prefilling and decoding.

17. The electronic device according to claim 16, further comprising:
in response to the memory space being unavailable, acquiring an empty target memory space; and
processing the candidate user request in the target memory space by using the pre-trained language model.

18. The electronic device according to claim 11, further comprising:
partitioning a memory space into a plurality of physical blocks of the same size; and
assigning a predetermined number of physical blocks to a plurality of user requests in the batch request.

19. The electronic device according to claim 11, further comprising:
determining whether a length of an input sequence corresponding to a given one of the user requests and a length of an output sequence corresponding to the input sequence are greater than a maximum sequence length; and
dynamically adjusting the maximum sequence length in response to the lengths being greater than the maximum sequence length.

20. A computer program product, the computer program product being tangibly stored on a non-transitory computer-readable storage medium and comprising machine-executable instructions, wherein the machine-executable instructions, when executed by a machine, cause the machine to perform:
processing a plurality of user requests in a batch request by using a pre-trained language model;
inputting a candidate user request into the pre-trained language model when it is detected that the pre-trained language model outputs a response result corresponding to at least one user request; and
processing the candidate user request and other user requests in the batch request by using the pre-trained language model, the other user requests comprising user requests other than the at least one user request in the batch request.
